(19) United States
(12) Patent Application Publication
(10) Pub. No.: US 2014/0289264 A1
(43) Pub. Date: Sep. 25, 2014

(54) ONE PASS SUBMATCH EXTRACTION

(71) Applicant: HEWLETT-PACKARD DEVELOPMENT COMPANY, L.P., Houston, TX (US)

(72) Inventors: William G. Horne, Lawrenceville, NJ (US); Miranda Jane Felicity Mowbray, Bristol (GB)

(73) Assignee: Hewlett-Packard Development Company, L.P., Houston, TX (US)

(21) Appl. No.: 13/848,562

(22) Filed: Mar. 21, 2013

(51) Int. Cl. G06F 17/27

(52) U.S. Cl. CPC G06F 17/2705
USPC 707/755

(57) ABSTRACT

A method for one pass submatch extraction may include receiving an input string, receiving a regular expression with capturing groups, and converting the regular expression with capturing groups into a finite automaton M to extract submatches. The finite automaton M may be evaluated to determine whether the regular expression belongs to a set of regular expressions for which submatch extraction is implemented by using one pass by determining whether an automaton M′=rev(close(M)) is deterministic. The input string may be matched to the regular expression if the regular expression belongs to the set of regular expressions for which submatch extraction is implemented by using one pass.

### BACKGROUND

Regular expressions provide a concise and formal way of describing a set of strings over an alphabet. Given a regular expression and a string, the regular expression matches the string if the string belongs to the set described by the regular expression. Regular expression matching may be used, for example, by command shells, programming languages, text editors, and search engines to search for text within a document.

### BRIEF DESCRIPTION OF DRAWINGS

Features of the present disclosure are illustrated by way of example and not limited in the following figure(s), in which like numerals indicate like elements, in which:

FIG. 1 illustrates an architecture of a one pass submatch extraction system, according to an example of the present disclosure;

FIG. 2 illustrates an architecture of an automata evaluation module of the one pass submatch extraction system, according to an example of the present disclosure;

FIG. 3 illustrates rules for construction of an automaton M, according to an example of the present disclosure;

FIGS. 4A-4F respectively illustrate construction of the one-pass automata for the regular expression (a|b)*=c, with FIG. 4A illustrating the automaton M, FIG. 4B illustrating close(M), FIG. 4C illustrating rev(M), FIG. 4D illustrating rev(close(M)), FIG. 4E illustrating close(rev(M)), and FIG. 4F illustrating rev(close(rev(M))), according to examples of the present disclosure;

FIGS. 5A-5F respectively illustrate construction of the one-pass automata for the regular expression (a|b)a*, with FIG. 5A illustrating the automaton M, FIG. 5B illustrating close(M), FIG. 5C illustrating rev(M), FIG. 5D illustrating rev(close(M)), FIG. 5E illustrating close(rev(M)), and FIG. 5F illustrating rev(close(rev(M))), according to examples of the present disclosure;

FIG. 6 illustrates processing of a string c=baaI by the deterministic automaton shown in FIG. 4D (i.e., rev(close(M))), according to an example of the present disclosure;

FIG. 7 illustrates processing of string c=aaI by the deterministic automaton shown in FIG. 5F (i.e., rev(close(rev(M)))), according to an example of the present disclosure;

FIG. 8 illustrates a method for one pass submatch extraction, according to an example of the present disclosure;

FIG. 9 illustrates further details of the method for one pass submatch extraction, according to an example of the present disclosure; and

FIG. 10 illustrates a computer system, according to an example of the present disclosure.

### DETAILED DESCRIPTION

For simplicity and illustrative purposes, the present disclosure is described by referring mainly to examples thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Regular expressions are a formal way to describe a set of strings over an alphabet. Regular expression matching is the process of determining whether a given string (for example, a string of text in a document) matches a given regular expression, that is, whether the given string is in the set of strings that the regular expression describes. Given a string that matches a regular expression, submatch extraction is a process of extracting substrings corresponding to specified subexpressions known as capturing groups. This feature provides for regular expressions to be used as parsers, where the submatches correspond to parsed substrings of interest. For example, the regular expression (.*)=(.*) may be used to parse key-value pairs, where the parentheses are used to indicate the capturing groups.

Finding the submatches of an input string to a regular expressions that contains capturing groups may be implemented by using automata. While certain implementations may use a plurality of automata and thus a plurality of passes of the input string to determine the correct submatches, in certain cases, finding the submatches of an input string to a regular expression may be implemented by using a single (i.e., one) pass. According to an example, a one pass submatch extraction system and a method for one pass submatch extraction are disclosed. The system and method disclosed herein may be used to determine at compile time whether a regular expression being considered belongs to the set of regular expressions that may be implemented by using a single pass, and if so, a single automaton may be used at runtime. By using a single-pass operation, the system and method disclosed herein provide improved efficiency by approximately a factor of two for the matching and submatching at runtime for the regular expressions in these sets compared to using a multiple-pass (e.g., two-pass) operation.

According to an example, the one pass submatch extraction system may include an input module to receive a regular expression. An automaton generation module may generate an automaton M for the received regular expression. An automaton M is defined as an abstract machine that can be in one of a finite number of states and includes rules for traversing the states. The automaton M may be stored in the system as machine readable instructions. An automaton evaluation module may determine whether the regular expression being considered belongs to the set of regular expressions that may be implemented by using a single pass, and if so, the single automaton M may be used at runtime. If the regular expression being considered does not belong to the set of regular expressions that are implemented by using a single pass, finding submatches of an input string to the regular expression may be implemented, for example, as described in detail in commonly owned and co-pending application Ser. No. 13/460,419 titled “Submatch Extraction”, Ser. No. 13/556,684 titled “Matching Regular Expressions including Word Boundary Symbols,” and PCT/US12/28916 titled “Submatch Extraction”. Further, the systems and methods described in co-pending application Ser. Nos. 13/460,419, 13/556,684, and PCT/US12/28916 may implement finding submatches of an input string to a regular expression either when the regular expression belongs to the set of regular expressions for which matching and submatch extraction can be implemented by using a single pass as described herein, or when the regular expression does not belong to this set.

In order for the automata evaluation module to determine whether the regular expression being considered belongs to the set of regular expressions for which matching and submatch extraction may be implemented by using a single pass, the automata evaluation module may determine whether the automaton M′ is deterministic (as described in further detail below), where M′=rev(close(M)) and M is the automaton corresponding to the regular expression built in the manner described below. If M′=rev(close(M)) is deterministic, then M′ is a one pass reverse automaton, and the one pass reverse automaton M′ (i.e., M′=rev(close(M))) may be used to process a string in reverse order. Further, the automata evaluation module may determine whether the automaton M″ is deterministic, where M″=rev(close(rev(M))) and M is the automaton corresponding to the regular expression built in the manner described below. If M″=rev(close(rev(M))) is deterministic, then M″ is a one pass forward automaton, and the one pass forward automaton M″ (i.e., M″=rev(close(rev(M)))) may be used to process a string in forward order.

The system and method disclosed herein may further include a comparison module to receive input strings, and match the input strings to the regular expression (i.e., if the regular expression being considered belongs to the set of regular expressions for which matching and submatch extraction may be implemented by using a single pass) by processing a string in a reverse or forward order respectively based on whether M′=rev(close(M)) is deterministic or M″=rev(close(rev(M))) is deterministic. In extracting submatches for an input string to the regular expression, the comparison module thus determines if the input string is in a language described by the regular expression, that is, whether it matches the regular expression. If an input string does not match the regular expression, submatches are not extracted. However, if an input string matches the regular expression, the output from the processing of the input string (i.e., the input string as processed by the comparison module) may be used to extract submatches by an extraction module. In this manner, the regular expression may be matched to many different input strings and submatches may be extracted from those input strings that match the regular expression.

According to an example, the one pass submatch extraction system may include a memory storing machine readable instructions to receive an input string, receive a regular expression with capturing groups, and convert the regular expression with capturing groups into a finite automaton M to extract submatches. The finite automaton M may be evaluated to determine whether the regular expression belongs to a set of regular expressions for which submatch extraction is implemented by using one pass by determining whether the automaton M′=rev(close(M)) is deterministic, and determining whether the automaton M″=rev(close(rev(M))) is deterministic. The input string may be matched to the regular expression if the regular expression belongs to the set of regular expressions for which submatch extraction is implemented by using one pass. The one pass submatch extraction system may include a processor to implement the machine readable instructions.

According to an example, the method for one pass submatch extraction may include receiving an input string, receiving a regular expression with capturing groups, and converting the regular expression with capturing groups into a finite automaton M to extract submatches. The finite automaton M may be evaluated to determine whether the regular expression belongs to a set of regular expressions for which submatch extraction is implemented by using one pass by determining whether the automaton M′=rev(close(M)) is deterministic. The input string may be matched to the regular expression if the regular expression belongs to the set of regular expressions for which submatch extraction is implemented by using one pass.

For the example of the one pass submatch extraction system whose construction is described in detail herein, the syntax of regular expressions with capturing groups and reluctant closure on a fixed finite alphabet Σ, for example the standard ASCII set of characters, is:

E:=ε|a|EE|E|E*|E*^{?}|(E)ₜ

For the syntax of regular expressions with capturing groups and reluctant closure on a fixed finite alphabet Σ, a stands for an element of the alphabet A, ε is the empty string, and the parentheses ( )ₜ indicate the t^{th} capturing group. The one pass submatch extraction system may use this syntax. Other examples of the one pass submatch extraction system may perform one pass submatch extraction for regular expressions written in a syntax that uses different notation to denote one or more of the operators introduced in the foregoing syntax of regular expressions with capturing groups and reluctant closure on a fixed finite alphabet Σ; or that does not include either or both of the operators * or *? in the foregoing syntax of regular expressions with capturing groups and reluctant closure on a fixed finite alphabet Σ; or that includes additional operators, such as, for example, special character codes, character classes, boundary matchers, quotation, etc.

Indices may be used to distinguish the capturing groups within a regular expression. Given a regular expression E containing c capturing groups marked by parentheses, indices 1, 2, . . . c may be assigned to each capturing group in the order of their left parentheses as E is read from left to right. The notation idx(E) may be used to refer to the resulting indexed regular expression. For example, if E=((a)*|b)(ab|b) then idx(E)=((a)₂*|b)₁(ab|b)₃.

If X, Y are sets of strings, XY is used to denote {xy: xεX, yεy}, and X|Y to denote X∪Y. If β is a string and B a set of symbols, β|_{B} denotes the string in B* obtained by deleting from β all elements that are not in B. A set of symbols T={Sₜ, Eₜ: 1≦t≦c} are introduced and may be referred to as tags. The tags may be used to encode the start and end of capturing groups. The language L(F) for an indexed regular expression F=idx(E), where E is a regular expression written in the foregoing syntax of regular expressions with capturing groups and reluctant closure on a fixed finite alphabet Σ, is a subset of (Σ∪T)*, defined by L(ε)={ε}, L(a)={a}, L(F₁F₂)=L(F₁)L(F₂), L(F₁|F₂)=L(F₁)∪L(F₂), L(F*)=L(F*^{?})=L(F)*, L([F])=L(F), and L((F)ₜ)=(SₜαEₜ: αεL(F)), where ( )ₜ denotes a capturing group with index t. There are standard ways to generalize this definition to other commonly-used regular expression operators, so that it can be applied to cases where the regular expression E is written in a commonly-used regular expression syntax different from the foregoing syntax of regular expressions with capturing groups and reluctant closure on a fixed finite alphabet Σ.

A valid assignment of submatches for regular expression E with capturing groups indexed by {1, 2, . . . c} and input string a is a map sub: {1, 2, . . . c}→Σ*∪{NULL} such that there exists βεL(E) satisfying the following three conditions:

(i) β|_{Σ}=α;
(ii) if Sₜ occurs in β then sub(t)=βₜ|_{Σ} where βₜ is the substring of β between the last occurrence of Sₜ and the last occurrence of Eₜ; and
(iii) if Sₜ does not occur in β then sub(t)=NULL.

If αεΣ*, α matches E if and only if α=β|_{Σ} for some βεL(E). For a regular expression without capturing groups, this coincides with the standard definition of the set of strings matching the expression. By definition, if there is a valid assignment of submatches for E and α, then α matches E. It may be proved by structural induction on E that the converse is also true, that is, whenever E matches α, there is at least one valid assignment of submatches for E and a. The one pass submatch extraction system may take as input a regular expression and an input string, and output a valid assignment of submatches to the capturing groups of the regular expression if there is a valid assignment, or report that the string does not match if there is no valid assignment.

The difference between the operators * and *? is not apparent in the set of valid assignments of submatches, but is apparent in which of these valid assignments is reported.

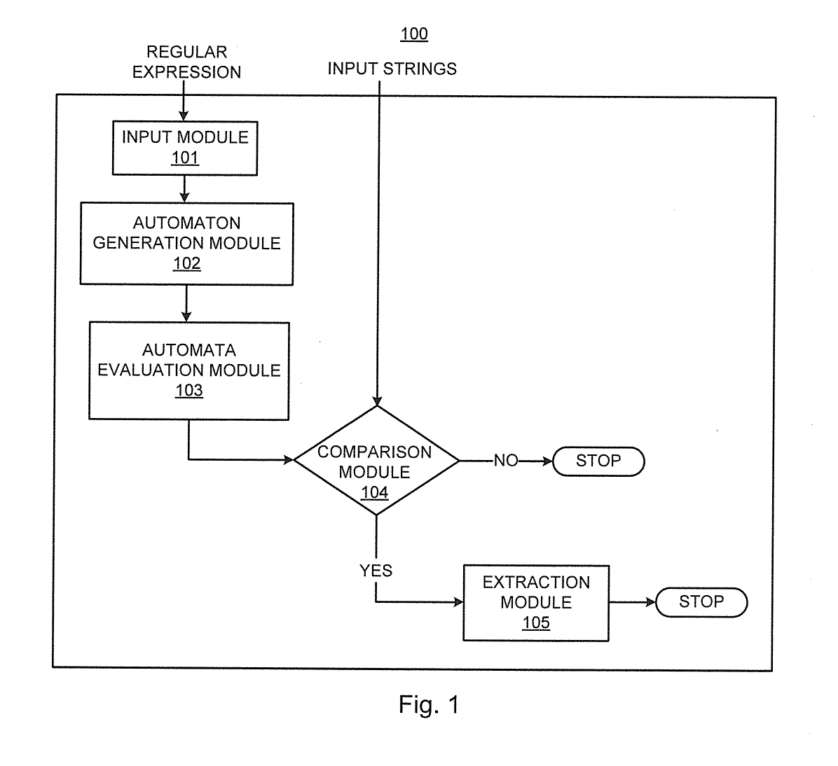

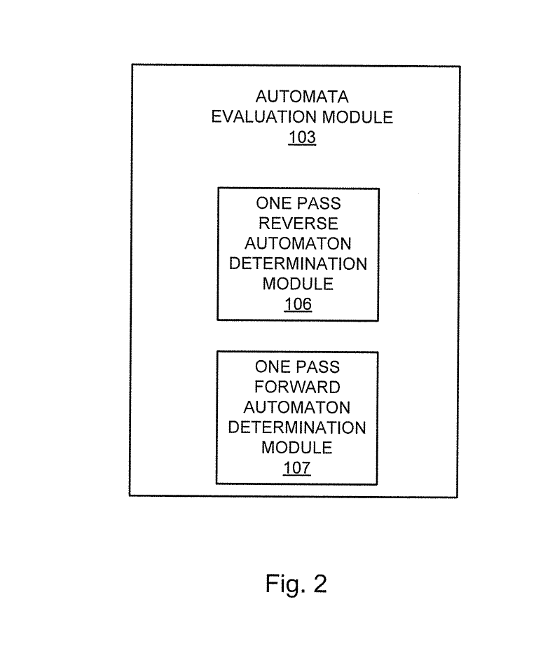

FIG. 1 illustrates an architecture of a one pass submatch extraction system 100, according to an example. Referring to FIG. 1, the system 100 may include an input module 101 to receive a regular expression. An automaton generation module 102 may generate an automaton M for the received regular expression. An automata evaluation module 103 may determine whether the regular expression being considered belongs to the set of regular expressions for which submatch extraction may be implemented by using a single pass, and if so, a single automaton M′ or M″ may be used at runtime. The automata evaluation module 103 is described in further detail below with reference to FIG. 2. If the regular expression being considered belongs to the set of regular expressions that for which submatch extraction may be implemented by using a single pass, a comparison module 104 may receive input strings, and match the input strings to the regular expression. If the regular expression being considered does not belong to the set of regular expressions for which submatch extraction is implemented by using a single pass, then the process of finding matches and submatches of the input string to the regular expression may be implemented, for example, as described in detail in commonly owned and co-pending application Ser. Nos. 13/460,419, 13/556,684, and PCT/US12/28916. If an input string does not match the regular expression, submatches are not extracted. However, if an input string matches the regular expression, the output from processing the input string (i.e., the input string as processed by the comparison module 104) may be used to extract submatches by an extraction module 105. Referring to FIG. 2, in order for the automata evaluation module 103 to determine whether the regular expression being considered belongs to the set of regular expressions for which submatch extraction may be implemented by using a single pass, the automata evaluation module 103 may include a one pass reverse automaton determination module 106 to determine whether for the automaton M, M′=rev(close(M)) is deterministic. If M′=rev(close(M)) is deterministic, the one pass reverse automaton determination module 106 may determine that M′ is a one pass reverse automaton, and the one pass reverse automaton M′ (i.e., M′=rev(close(M))) may be used by the comparison module 104 to process an input string in a reverse order. Further, the automata evaluation module 103 may include a one pass forward automaton determination module 107 to determine whether for the automaton M″, M″=rev(close(rev(M))) is deterministic. If M″=rev(close(rev(M))) is deterministic, the one pass forward automaton determination module 107 may determine that M″ is a one pass forward automaton, and the one pass forward automaton M″ (i.e., M″=rev(close(rev(M)))) may be used by the comparison module 104 to process an input string in a forward order.

The modules 101-107, and other components of the system 100 that perform various other functions in the system 100, may include machine readable instructions stored on a non-transitory computer readable medium. In addition, or alternatively, the modules 101-107, and other components of the system 100 may include hardware or a combination of machine readable instructions and hardware.

The components of the system 100 are described in further detail with reference to FIGS. 1-7.

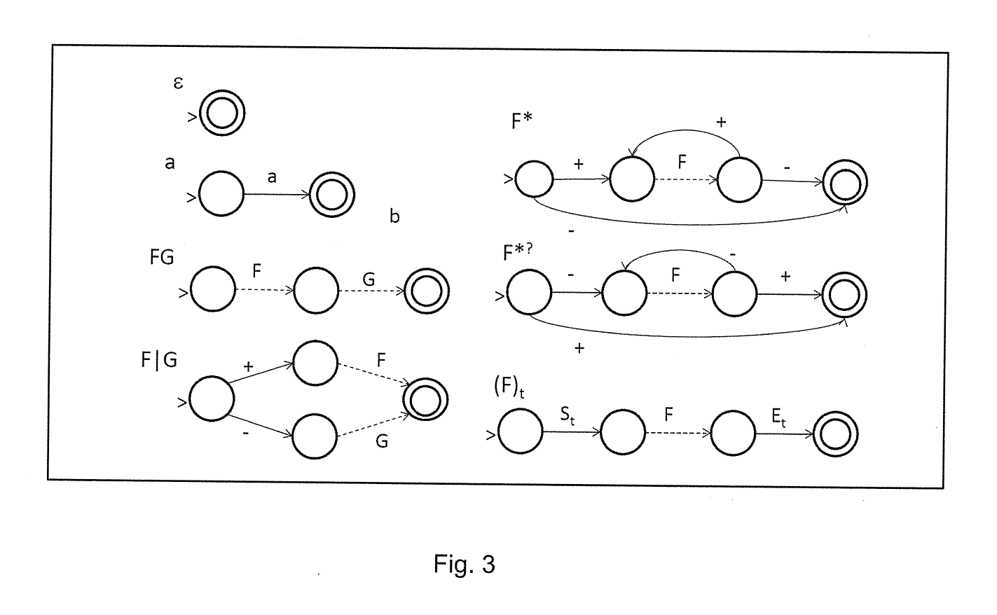

Referring to FIG. 1, for a regular expression E received by the input module 101, the regular expression E may be fixed and indices may be assigned to each capturing group to form idx(E). In order for the automaton generation module 102 to generate the automaton M, M may be specified by the tuple (Σ, Q, Δ, S, F), where Σ is the input alphabet, Q is the set of states, Δ⊂Q×Σ×Q is the set of transitions, S is the set of initial states, and F is the set of final states. Δ is built using structural induction on the indexed regular expression, idx(E), following the rules illustrated by the diagrams of FIG. 3. For this example it is assumed that the syntax of the regular expression is the foregoing syntax of regular expressions with capturing groups and reluctant closure on a fixed finite alphabet Σ. In FIG. 3, the initial state of the automaton is marked with > and the final state is marked with a double circle. A dashed arrow with label F or G is used as shorthand for the diagram corresponding to the indexed expression F or G. The automaton M uses separate transitions with labels Sₜ and Eₜ to indicate the start and end of a capturing group with index t, in addition to transitions labeled with + and − to indicate submatching priorities.

The automaton M may be considered as a directed graph. If x is any directed path in M, ls(x) denotes its label sequence. Let π: Q₁×Q₁→T* be a mapping from a pair of states to a sequence of tags defined as follows. For any two states q, pεQ₁, consider a depth-first search of the graph of M, beginning at q and searching for p, using only transitions with labels from T∪{+, −}, and such that at any state with outgoing transitions labeled ‘+’ and ‘−’, the search explores all states reachable via the transition labeled ‘+’ before following the transition labeled ‘−’. If this search succeeds in finding successful search path λ(q, p), then π(q, p)=ls(λ(q, p))|_{T} is the sequence of tags along this path. If the search fails, then π(q, p) is undefined. π(p, p) is defined to be the empty string. It can be shown that this description of the search uniquely specifies λ(q, p), if it exists.

In order for the automaton generation module 102 to generate the automaton M, as described above, the syntax of regular expressions with capturing groups and reluctant closure on a fixed finite alphabet Σ, for example the standard ASCII set of characters, is:

E:=ε|a|EE|E|E|E*|E*^{?}|(E)ₜ

The automaton generation module 102 may use the rules of FIG. 3 to process the regular expression into the automaton M, specified by the tuple:

(Σ,Q,Δ,S,F),

where

Σ=A∪E∪{Sₜ,Eₜ:tεT},

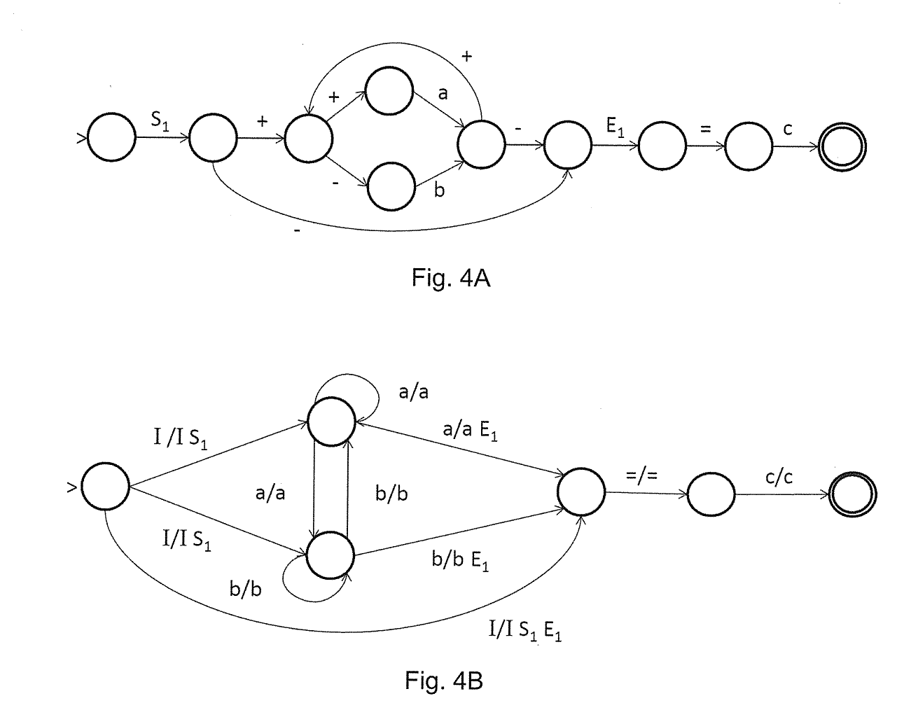

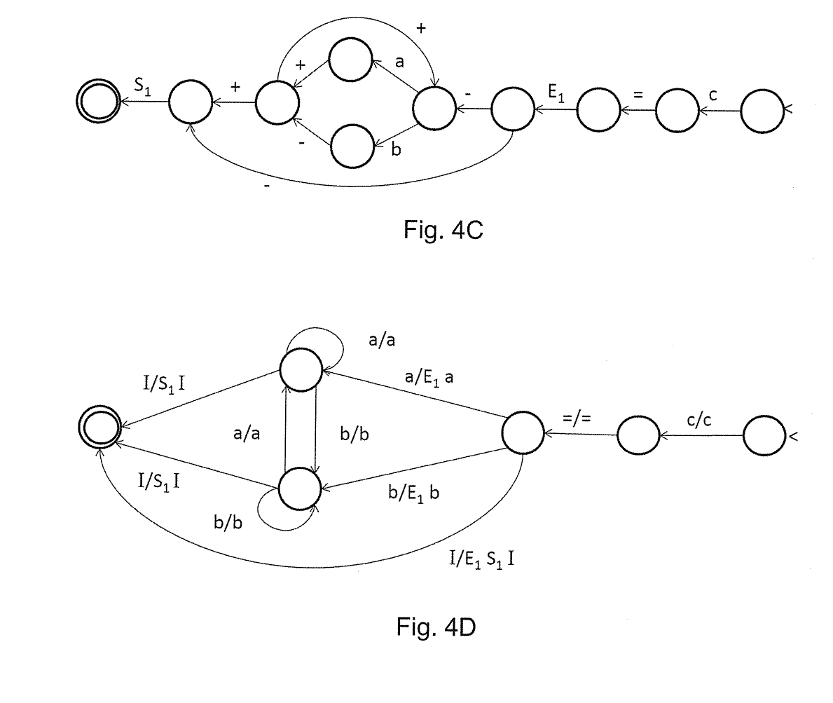

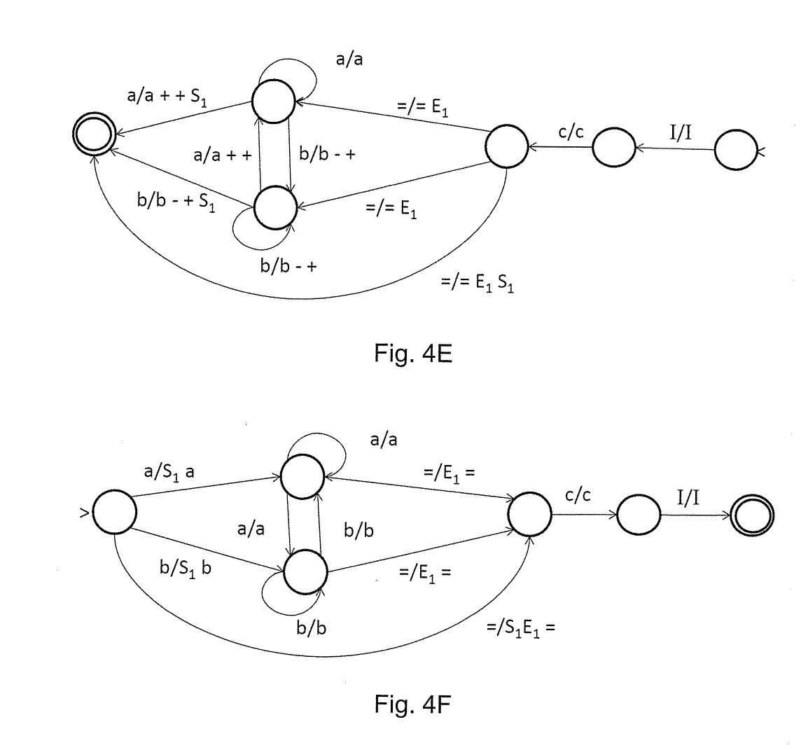

E={+,−}, and the set T indexes the capturing groups of the regular expression. Referring to FIG. 3, in the diagram for an automaton (Σ, Q, Δ, S, F), states in Q are represented by circles, a transition (p,σ,q) in Δ is indicated by an arrow labelled σ from the circle representing β to the circle representing q, a transition (p,σ,q,γ) in Δ is indicated by an arrow labelled σ/γ (e.g., see FIG. 4B) from the circle representing p to the circle representing q, states in S are indicated by >, and states in F are indicated by a double circle. In the diagrams of FIG. 3, a dashed arrow labelled F or G is used as shorthand for the diagram corresponding to the expression F or G.

Referring to FIGS. 1 and 2, in order for the automata evaluation module 103 to determine whether the regular expression being considered belongs to the set of regular expressions that may be implemented by using a single pass, the one pass reverse automaton determination module 106 may determine whether for the automaton M generated by the automaton generation module 102, the automaton M′=rev(close(M)) is deterministic. Further, the one pass forward automaton determination module 107 may determine whether for the automaton M generated by the automaton generation module 102, the automaton M″=rev(close(rev(M))) is deterministic.

The rev and close operations are defined as follows.

With respect to the rev operation, the notation reverse(α) may be used for the reverse of a string α, such that if α=α₁.a₂ . . . aₙ, then reverse(α)=aₙ.aₙ₋₁ . . . a₁. The automaton M may be specified by the tuple:

(Σ,Q,Δ,S,F),

where Σ is the input alphabet, Q is the set of states, Δ is the set of transitions, S is the set of initial states, and F is the set of final states, and either Δ⊂Q×Σ×Q (so that the automaton has no outputs) or Δ⊂Q×Σ×Q×C* for some alphabet C of output characters (so that the outputs of the automaton M are strings over C.) For the rev operation, rev(M) is an automaton that matches a string a if and only if M matches reverse(α). For the rev operation, rev(M) is specified by the tuple:

(Σ,Q,r(Δ),F,S),

where r(Δ)={(p,σ,q): (q,σ,p)εΔ} if Δ⊂Q×Σ×Q, and
r(Δ)={(p,σ,q,reverse(γ)): (q,σ,p,γ)εΔ} if Δ⊂Q×Σ×Q×C*.

With respect to the close operation, the automaton M may be specified by the tuple:

(Σ,Q,Δ,S,F),

where Σ is the input alphabet, Q is the set of states, Δ⊂Q×Σ×Q is the set of transitions, S is the set of initial states, and F is the set of final states. For the close operation, close(M) is an automaton for which transitions in close(M) correspond to paths in the automaton M. The definition of close(M) is relative to two particular subsets A, E of Σ, and uses a new label I not in Σ and a new state q₀ not in Q. For the close operation, A, E, I and q₀ are fixed. For p, qεQ and γεΣ*, p [symbol] γq may be written to mean that there are transitions as follows:
(q₁,σ₁,q₂), (q₂,σ₂,q₃) . . . (qₙ,σₙ,qₙ₊₁)εΔ,
   such that n≧0, q₁=p, qₙ₊₁=q, and γ is the string obtained by deleting all characters in E from the string σ₁.σ₂ . . . σₙ. Then close(M) is the automaton specified by the tuple:

(A∪{I},Q′,Δ′,{q₀},F),

where Q′={q₀}∪{pεQ: (p,σ,q)εΔ for some σεA, qεQ}∪F, and Δ′⊂Q′×(A∪{I})×Q′×(Σ∪{I})* is the set:
{(q₀, I, q, I.γ): qεQ′, γε(Σ/A)*, ∃ pεS such that p [symbol] γ q}
∪{(p, σ, q, σ.γ): p, qεQ′, σεA, γε(Σ/A)*, p₁ [symbol] σ.γ q}

With respect to whether an automaton is deterministic, if M=(Σ, Q, Δ, S, F) is an automaton such that Δ⊂Q×Σ×Q×C* and |S|=1, then the automaton M is deterministic if the start state and input of a transition uniquely determine the end state and output. Specifically, the automaton M is deterministic if and only if

(p, σ, q₁, γ₁), (p, σ, q₂, γ₂)εΔ implies q₁=q₂ and γ₁=γ₂.

Based on the foregoing definitions related to the rev and close operations, and based on the foregoing definition of whether an automaton is deterministic, the one pass reverse automaton determination module 106 may determine whether for the automaton M generated by the automaton generation module 102, the automaton M′=rev(close(M)) is deterministic. Further, the one pass forward automaton determination module 107 may determine whether for the automaton M generated by the automaton generation module 102, the automaton M″=rev(close(rev(M))) is deterministic. Thus the one pass reverse automaton determination module 106 and the one pass forward automaton determination module 107 may respectively generate the automata V=rev(close(M)) and M″=rev(close(rev(M))), and check whether these automata are deterministic.

With respect to the close operation, the close operation introduces a new label I the one pass reverse automaton determination module 106 confirms that the automaton M′=rev(close(M)) is deterministic, in order for the comparison module 104 to determine whether the string a matches the regular expression, the comparison module 104 processes the string reverse(α).I by the automaton M′=rev(close(M)). The processing will terminate with success if and only if the string a matches the regular expression. If the processing terminates with success, then there will be n+1 processing steps, where n is the length of string α. For 1≦i≦n+1, the comparison module 104 writes γᵢ for the string output by step i, and sets γ=reverse(γ₁.γ₂ . . . γₙ₊1). In order to obtain the submatch of the string a to the t^{th} capturing group of the regular expression, the extraction module 105 finds the substring of γ lying between the last occurrence of Sₜ and the last occurrence of Eₜ in γ, and deletes all characters from this substring that are not in A.

If the one pass forward automaton determination module 107 confirms that the automaton M″=rev(close(rev(M))) is deterministic, in order for the comparison module 104 to determine whether the string a matches the regular expression, the comparison module 104 processes the string α.I by the automaton M″=rev(close(rev(M))). The processing will terminate with success if and only if the string α matches the regular expression. If the processing terminates with success, then there will be n+1 processing steps, where n is the length of string a. For 1≦i≦n+1, the comparison module 104 writes γᵢ for the string output by step i, and sets γ=γ₁.γ₂ . . . γₙ₊1. In order to obtain the submatch of the string α to the t^{th} capturing group of the regular expression, the extraction module 105 finds the substring of γ lying between the last occurrence of Sₜ and the last occurrence of Eₜ in γ, and deletes all characters from this substring that are not in A.

Referring to FIGS. 1, 2, and 4A-4F, FIGS. 4A-4F respectively illustrate construction of the one-pass automata for the regular expression (a|b)*=c, with FIG. 4A illustrating the automaton M, FIG. 4B illustrating close(M), FIG. 4C illustrating rev(M), FIG. 4D illustrating rev(close(M)), FIG. 4E illustrating close(rev(M)), and FIG. 4F illustrating rev(close(rev(M))), according to examples of the present disclosure. For the regular expression (a|b)*=c, and input string aab=c, the alphabet A is {a,b,c,=}. In the diagram for an automaton (Σ, Q, Δ, S, F), states in Q are represented by circles, a transition (p,σ,q) in Δ is indicated by an arrow labelled a from the circle representing p to the circle representing q, a transition (p,σ,q,γ) in Δ is indicated by an arrow labelled σ/γ from the circle representing p to the circle representing q, states in S are indicated by >, and states in F are indicated by a double circle.

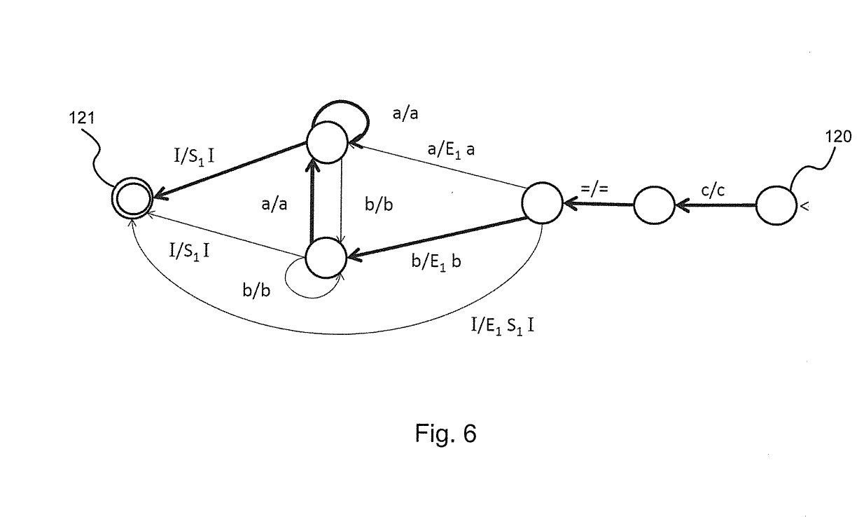

Referring to FIGS. 1, 2, 4D, and 4F, for the foregoing example of the regular expression (a|b)*=c, the one pass reverse automaton determination module 106 confirms that the automaton M′=rev(close(M)) is deterministic, and the one pass forward automaton determination module 107 confirms that the automaton M″=rev(close(rev(M))) is not deterministic. In order for the comparison module 104 to determine whether string aab=c matches the regular expression (a|b)*=c, the comparison module 104 uses the automaton shown in FIG. 4D (i.e., A/1=rev(close(M))) to process the string reverse(aab=c).I (i.e., the string c=baaI). This processing by the comparison module 104 is illustrated in FIG. 6, where the bold arrows indicate the path taken during the processing. Referring to FIG. 6, the processing of a string a₁a₂ . . . aₙ by a deterministic automaton M′=rev(close(M)) starts at the circle marked with > (e.g., at 120). At step i, the comparison module 104 determines whether there is any arrow from the current circle with a label aᵢ/γ for some γ. If there is no such arrow the processing terminates, declaring failure. If there is any such arrow, there will be exactly one such arrow, and the processing outputs γ and moves to the circle that is the target of the arrow. If at the end of step n the processing has reached a double circle (e.g., at 121), the processing terminates, and the comparison module 104 indicates that the string aab=c matches the regular expression (a|b)*=c.

Referring to FIGS. 1, 2, 4D, and 4F, continuing with the foregoing example of the regular expression (a|b)*=c, since the processing by the comparison module 104 terminates with success, the comparison module 104 determines that the input string matches the regular expression. The outputs of the six steps of this processing are c,=, E₁b, a, a, and S₁I (i.e., as indicated by the bold arrows of FIG. 6), and the string reverse(c=E₁baaS₁I) is equal to IS₁aabE₁. In order to find the submatch of aab=c to the first (and only) capturing group in the regular expression, the extraction module 105 takes the substring of IS₁aabE₁ lying between the last occurrence of S₁ and the last occurrence of E₁, and deletes all characters from this substring that are not in A, with the result being aab.

According to another example, the comparison module 104 may process a string a₁ a₂ . . . aₗ in reverse order with a one pass reverse automaton (i.e., M′=rev(close(M))). The submatch boundaries are determined by the tags Sᵢ and Eᵢ. If a tag occurs on a transition corresponding to aⱼ, the boundary is defined to be between positions j and j+1. For example, when processing the string abc=x, the tag E₁ occurs while processing the character c. Since c is the 3^{rd} character, the tag E₁ indicates that the submatch ends between the 3^{rd} and 4^{th} characters.

Submatch extraction for a variety of regular expressions may be implemented by a one-pass reverse automaton (i.e., the one pass reverse automaton determination module 106 confirms that the automaton M′=rev(close(M)) is deterministic) which contain no closure operations, or contain exactly one closure operation at the end of the regular expression. Examples of such regular expressions that may be used in a practical application are as follows:

(\S+?) peers exist on IIDB (\S+?)\.
State machine return code: (\S+?), (\S+?)
Submatch extraction for the foregoing regular expressions may be implemented by a one-pass reverse automaton (i.e., M′=rev(close(M))).

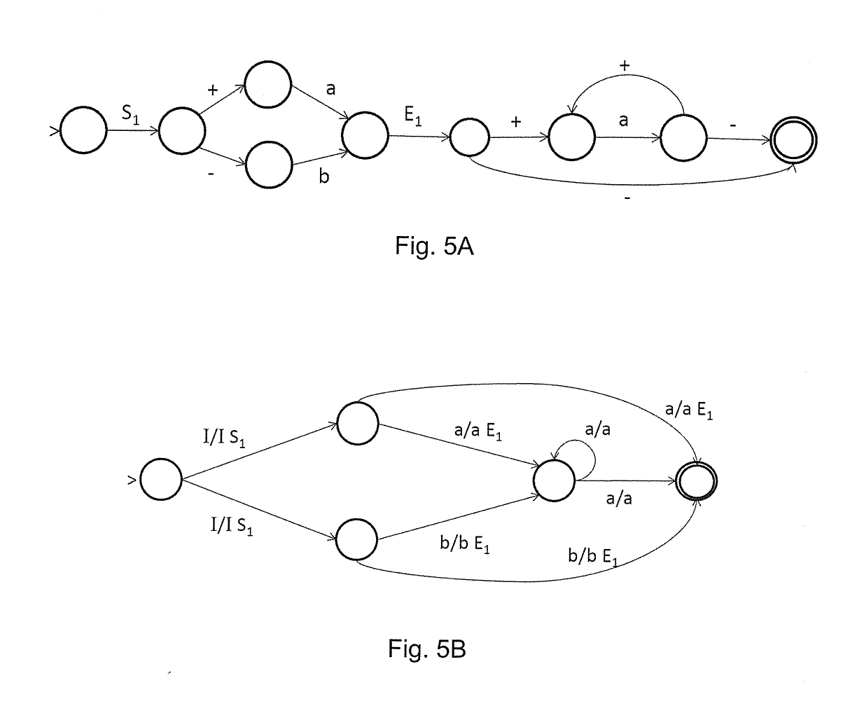

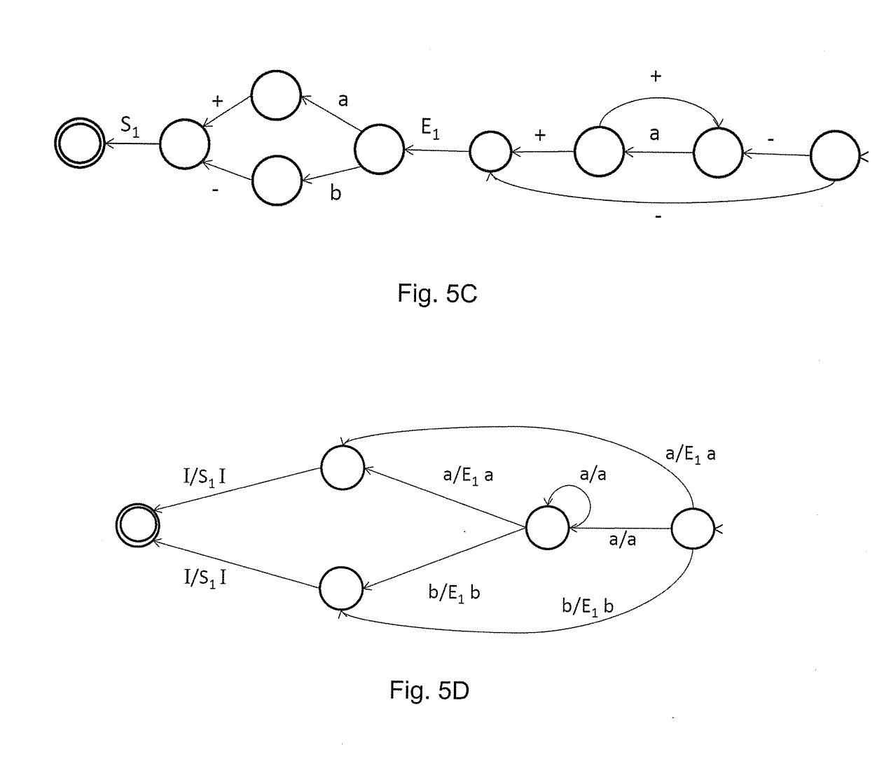

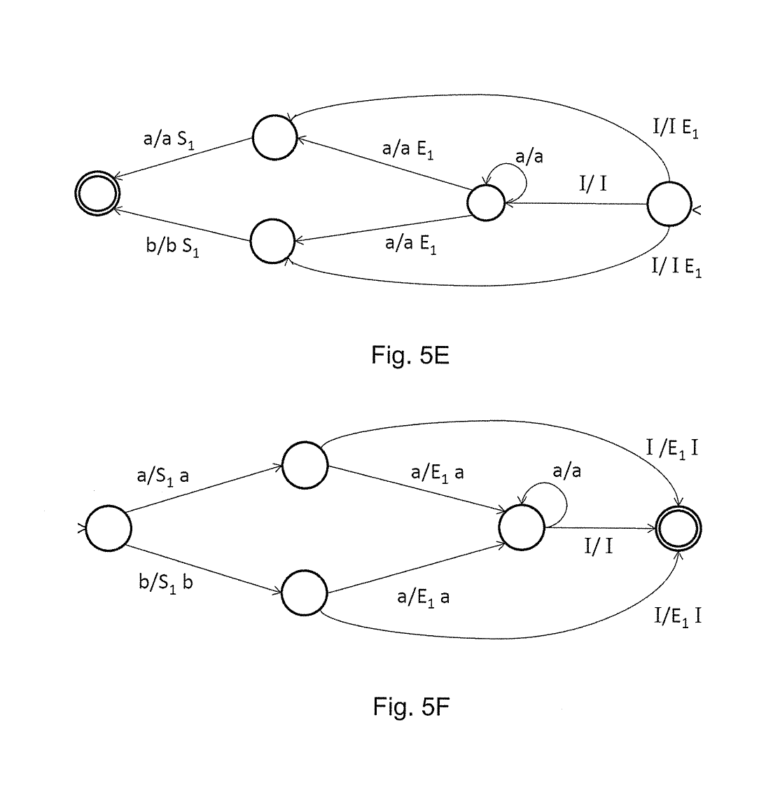

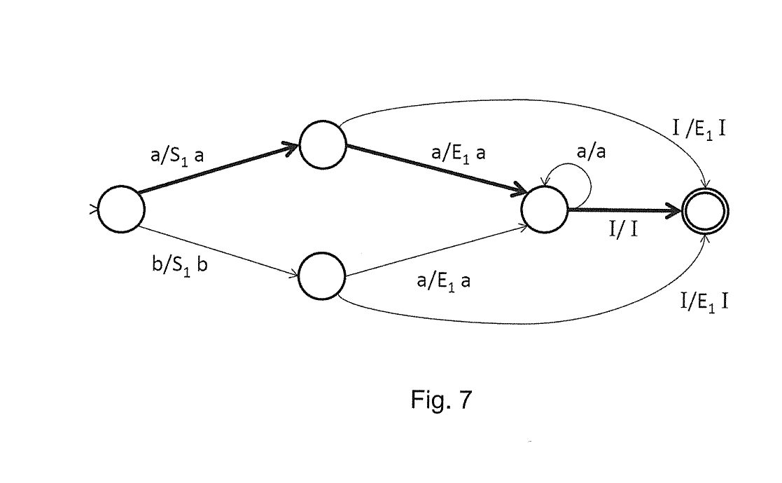

Referring to FIGS. 1, 2, and 5A-5F, FIGS. 5A-5F respectively illustrate construction of the one-pass automata for the regular expression (a|b)a*, with FIG. 5A illustrating the automaton M, FIG. 5B illustrating close(M), FIG. 5C illustrating rev(M), FIG. 5D illustrating rev(close(M)), FIG. 5E illustrating close(rev(M)), and FIG. 5F illustrating rev(close(rev(M))), according to examples of the present disclosure. Referring to FIGS. 1, 2, 5D, and 5F, the one pass reverse automaton determination module 106 confirms that the automaton M′=rev(close(M)) is not deterministic, and the one pass forward automaton determination module 107 confirms that the automaton M″=rev(close(rev(M))) is deterministic. In order for the comparison module 104 to determine whether input string as matches the regular expression (a|b)a*, the comparison module 104 uses the automaton shown in FIG. 5F (i.e., M″=rev(close(rev(M)))) to process the string aaI. This processing by the comparison module 104 is illustrated in FIG. 7, where the bold arrows indicate the path taken during the processing. Since the processing terminates with success, the comparison module 104 determines that the input string matches the regular expression. The outputs of the three steps of this processing are S₁a, E₁a, and I (i.e., as indicated by the bold arrows of FIG. 7). In order to find the submatch of as to the first (and only) capturing group of the regular expression, the extraction module 105 takes the substring of S₁aE₁aI lying between the last occurrence of S₁ and the last occurrence of E₁, and deletes all characters from this substring that are not in A, with the result being a.

According to another example, the comparison module 104 may process a string a₁a₂ . . . aₗ in forward order with a one pass forward automaton (i.e., M″=rev(close(rev(M)))). If a tag occurs on a transition corresponding to aⱼ, then the boundary is defined to be between positions j−1 and j. For example, when processing the string x=def, the tag S₁ occurs while processing the character d. Since d is the 3^{rd} character, the tag S₁ indicates that the submatch starts between the 2^{nd} and 3^{rd} characters.

Submatch extraction for a variety of regular expressions may be implemented by a one-pass forward automaton (i.e., the one pass forward automaton determination module 107 confirms that the automaton M″=rev(close(rev(M))) is deterministic) which contain no closure operations, or contain exactly one closure operation at the end of the regular expression. Examples of such regular expressions that may be used in a practical application are as follows:

Interface (\S+?) is down\.?
Unexpected event (\S+?) (\S+?)
Submatch extraction for the foregoing regular expressions may be implemented by a one-pass forward automaton (i.e., M″=rev(close(rev(M)))).

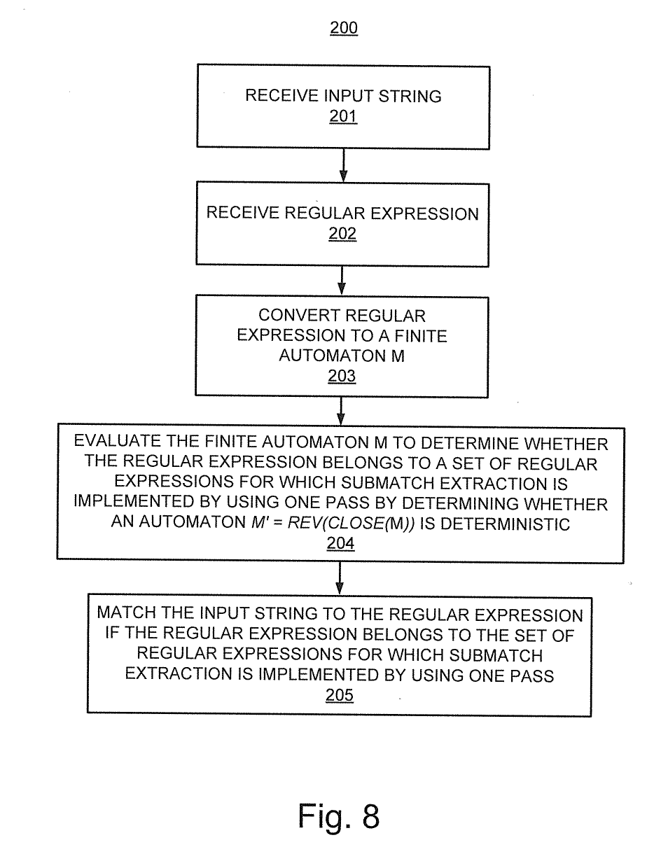

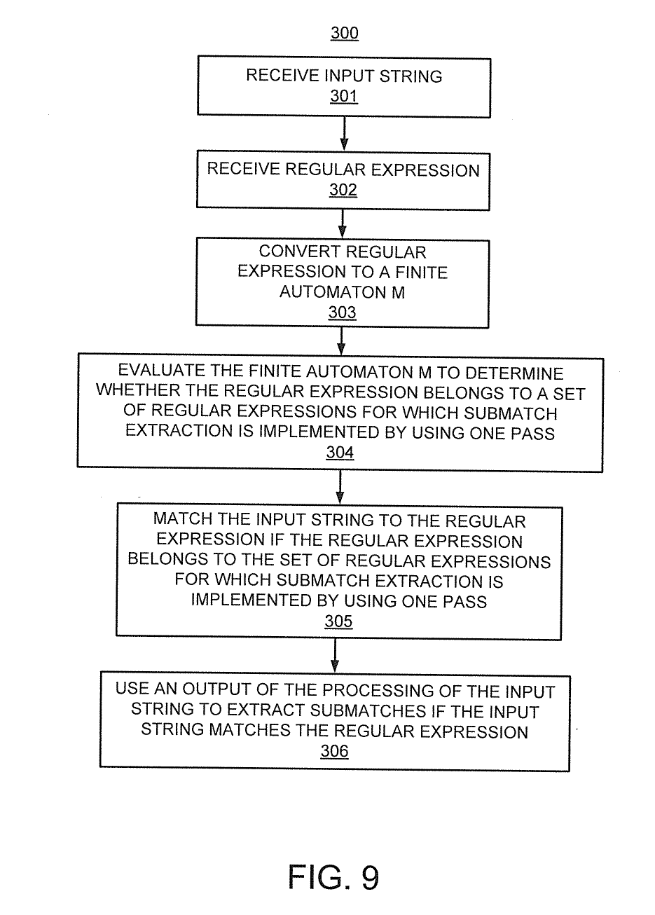

FIGS. 8 and 9 illustrate flowcharts of methods 200 and 300 for one pass submatch extraction, corresponding to the example of the one pass submatch extraction system 100 whose construction is described in detail above. The methods 200 and 300 may be implemented on the one pass submatch extraction system 100 with reference to FIGS. 1-7 by way of example and not limitation. The methods 200 and 300 may be practiced in other systems.

Referring to FIG. 8, at block 201, the example method includes receiving an input string.

At block 202, the example method includes receiving a regular expression.

At block 203, the example method includes converting the regular expression with capturing groups into a finite automaton M to extract submatches. In this example method, the construction of the finite automaton M is described above.

At block 204, the example method includes evaluating the finite automaton M to determine whether the regular expression belongs to a set of regular expressions for which submatch extraction is implemented by using one pass by determining whether the automaton M′=rev(close(M)) is deterministic.

At block 205, the example method includes matching the input string to the regular expression if the regular expression belongs to the set of regular expressions for which submatch extraction is implemented by using one pass.

Referring to FIG. 9, the further detailed method 300 for one pass submatch extraction is described. At block 301, the example method includes receiving an input string.

At block 302, the example method includes receiving a regular expression.

At block 303, the example method includes converting the regular expression with capturing groups into a finite automaton M to extract submatches. In this example method, the construction of the finite automaton M is described above.

At block 304, the example method includes evaluating the finite automaton M to determine whether the regular expression belongs to a set of regular expressions for which submatch extraction is implemented by using one pass. Evaluating the finite automaton M to determine whether the regular expression belongs to a set of regular expressions for which submatch extraction is implemented by using one pass further includes determining whether the automaton M′=rev(close(M)) is deterministic, and determining whether the automaton M″=rev(close(rev(M))) is deterministic.

At block 305, the example method includes matching the input string to the regular expression if the regular expression belongs to the set of regular expressions for which submatch extraction is implemented by using one pass. Matching the input string to the regular expression further includes using the automaton M′=rev(close(M)) to process the input string in a reverse order if M′=rev(close(M)) is deterministic, or using the automaton M″=rev(close(rev(M))) to process the input string in a forward order if M″=rev(close(rev(M))) is deterministic.

At block 306, the example method includes using an output of the processing of the input string to extract submatches if the input string matches the regular expression.

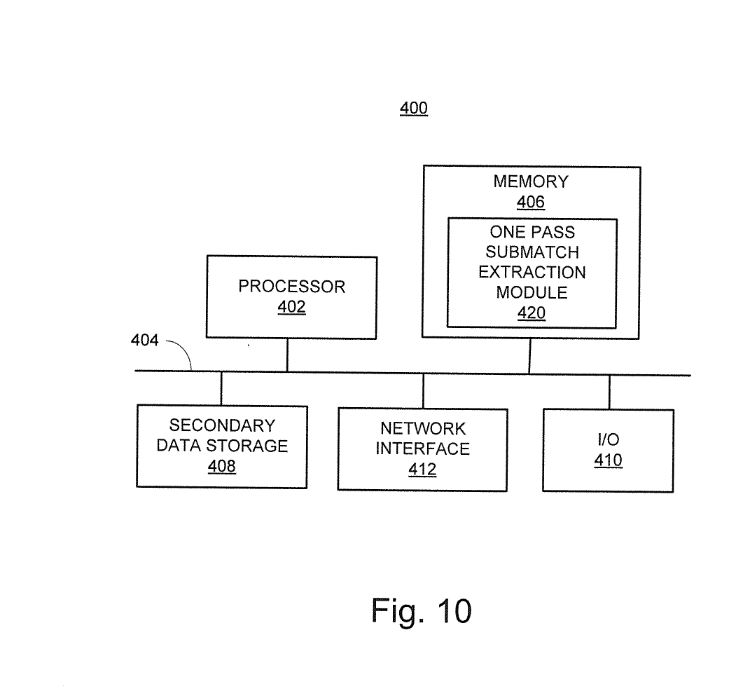

FIG. 10 shows a computer system 400 that may be used with the examples described herein. The computer system represents a generic platform that includes components that may be in a server or another computer system. The computer system 400 may be used as a platform for the system 100. The computer system 400 may execute, by a processor or other hardware processing circuit, the methods, functions and other processes described herein. These methods, functions and other processes may be embodied as machine readable instructions stored on a computer readable medium, which may be non-transitory, such as hardware storage devices (e.g., RAM (random access memory), ROM (read only memory), EPROM (erasable, programmable ROM), EEPROM (electrically erasable, programmable ROM), hard drives, and flash memory).

The computer system 400 includes a processor 402 that may implement or execute machine readable instructions performing some or all of the methods, functions and other processes described herein. Commands and data from the processor 402 are communicated over a communication bus 404. The computer system also includes a main memory 406, such as a random access memory (RAM), where the machine readable instructions and data for the processor 402 may reside during runtime, and a secondary data storage 408, which may be non-volatile and stores machine readable instructions and data. The memory and data storage are examples of computer readable mediums. The memory 406 may include a one pass submatch extraction module 420 including machine readable instructions residing in the memory 406 during runtime and executed by the processor 402. The one pass submatch extraction module 420 may include the modules 101-107 of the system shown in FIG. 1.

The computer system 400 may include an I/O device 410, such as a keyboard, a mouse, a display, etc. The computer system may include a network interface 412 for connecting to a network. Other known electronic components may be added or substituted in the computer system.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. A method for one pass submatch extraction, the method comprising:
receiving an input string;
receiving a regular expression with capturing groups;
converting, by a processor, the regular expression with capturing groups into a finite automaton M to extract submatches;
evaluating the finite automaton M to determine whether the regular expression belongs to a set of regular expressions for which submatch extraction is implemented by using one pass by determining whether an automaton M′=rev(close(M)) is deterministic; and
matching the input string to the regular expression if the regular expression belongs to the set of regular expressions for which submatch extraction is implemented by using one pass.

2. The method of claim 1, wherein matching the input string to the regular expression further comprises:
using the automaton M′=rev(close(M)) to process the input string in a reverse order if the automaton M′=rev(close(M)) is deterministic.

3. The method of claim 2, further comprising:
using an output of the processing of the input string to extract submatches if the input string matches the regular expression.

4. The method of claim 1, wherein evaluating the finite automaton M to determine whether the regular expression belongs to the set of regular expressions for which submatch extraction is implemented by using one pass further comprises:
determining whether an automaton M″=rev(close(rev(M))) is deterministic.

5. The method of claim 4, wherein matching the input string to the regular expression further comprises:
using the automaton M″=rev(close(rev(M))) to process the input string in a forward order if the automaton M″=rev(close(rev(M))) is deterministic.

6. The method of claim 5, further comprising:
using an output of the processing of the input string to extract submatches if the input string matches the regular expression.

7. A one pass submatch extraction system comprising:
a memory storing machine readable instructions to:
receive an input string;
receive a regular expression with capturing groups;
convert the regular expression with capturing groups into a finite automaton M to extract submatches;
evaluate the finite automaton M to determine whether the regular expression belongs to a set of regular expressions for which submatch extraction is implemented by using one pass by:
determining whether an automaton M′=rev(close(M)) is deterministic, and
determining whether an automaton M″=rev(close(rev(M))) is deterministic; and
match the input string to the regular expression if the regular expression belongs to the set of regular expressions for which submatch extraction is implemented by using one pass; and
a processor to implement the machine readable instructions.

8. The one pass submatch extraction system of claim 7, wherein the machine readable instructions to match the input string to the regular expression further comprise:
using the automaton M′=rev(close(M)) to process the input string in a reverse order if M′=rev(close(M)) is deterministic, or
using the automaton M″=rev(close(rev(M))) to process the input string in a forward order if M″=rev(close(rev(M))) is deterministic.

9. The one pass submatch extraction system of claim 8, further comprising machine readable instructions to:
use an output of the processing of the input string to extract submatches if the input string matches the regular expression.

10. A non-transitory computer readable medium having stored thereon machine readable instructions to provide one pass submatch extraction, the machine readable instructions, when executed, cause a computer system to:
receive an input string;
receive a regular expression with capturing groups;
convert, by a processor, the regular expression with capturing groups into a finite automaton M to extract submatches;
evaluate the finite automaton M to determine whether the regular expression belongs to a set of regular expressions for which submatch extraction is implemented by using one pass by determining whether an automaton M″=rev(close(rev(M))) is deterministic; and
match the input string to the regular expression if the regular expression belongs to the set of regular expressions for which submatch extraction is implemented by using one pass.

11. The non-transitory computer readable medium of claim 10, further comprising machine readable instructions to:
use the automaton M″=rev(close(rev(M))) to process the input string in a forward order if the automaton M″=rev(close(rev(M))) is deterministic.

12. The non-transitory computer readable medium of claim 11, further comprising machine readable instructions to:
use an output of the processing of the input string to extract submatches if the input string matches the regular expression.

13. The non-transitory computer readable medium of claim 10, wherein to evaluate the finite automaton M to determine whether the regular expression belongs to a set of regular expressions for which submatch extraction is implemented by using one pass further comprises machine readable instructions to:
determine whether an automaton M′=rev(close(M)) is deterministic.

14. The non-transitory computer readable medium of claim 13, further comprising machine readable instructions to:
use the automaton M′=rev(close(M)) to process the input string in a reverse order if the automaton M′=rev(close(M)) is deterministic.

15. The non-transitory computer readable medium of claim 14, further comprising machine readable instructions to:
use an output of the processing of the input string to extract submatches if the input string matches the regular expression.
